(19) United States
(12) Patent Application Publication
(10) Pub. No.: US 2026/0057156 A1
(43) Pub. Date: Feb. 26, 2026

(54) Integrated Circuit Device Recommendation System for Electronic System Architectures

(71) Applicant: Gildas Genest, Huntington Beach, CA (US)

(72) Inventor: Gildas Genest, Huntington Beach, CA (US)

(21) Appl. No.: 19/374,422

(22) Filed: Oct. 30, 2025

(51) Int. Cl. G06F 30/31; G06F 115/08

(52) U.S. Cl. CPC G06F 30/31; G06F 2115/08

(57) ABSTRACT

Systems and methods for generating system architecture recommendations for integrated circuit devices. In particular, a system architecture recommendation system may receive plain language inputs from a client device that may provide requested specifications of an integrated circuit device to be implemented in an electronic system. The system architecture recommendation system may query the client device for information related to a configuration of the electronic system. The system architecture recommendation system may query multiple data sources through an application programming interface (API) gateway to retrieve integrated circuit device data. The system architecture recommendation system may generate a system architecture recommendation by using the integrated circuit device data to determine which integrated circuit devices are compatible with the electronic system and satisfy the requested specifications of the integrated circuit device from the client device.

### BACKGROUND

The present disclosure relates generally to integrated circuit devices, such as processors and/or field-programmable gate arrays (FPGAs). More particularly, the disclosure relates to systems and methods for generating integrated circuit recommendations for electronic systems.

Electronic systems, including electronic devices and systems that may include multiple electronic devices, may include integrated circuit devices, such as field programmable gate arrays (FPGAs), complex programmable logic devices (CPLDs), system-on-a-chip (SoC) devices, memory devices (e.g., high bandwidth memory devices (HBMs)), chiplets, and the like. These integrated circuit devices may serve various functions in an electronic system. For example, many integrated circuits, such as FPGAs, include programmable logic circuitry that may be configured with a hardware system design to implement hardware system designs that may perform a wide variety of different functions. In addition to programmable logic circuitry, many integrated circuits also include hardened circuits to perform special-purpose operations, such as data processing. Indeed, integrated circuit devices may be designed or, in the case of an FPGA, may be configured, to perform multiple functions. Because of the wide functionality of integrated circuit devices and the complexity of electronic systems (e.g., system design architectures, desired specifications of electronic systems), it may be difficult for those seeking to use integrated circuit devices to identify and determine which integrated circuit devices are available, suitable for their electronic system designs, and may be cost and resource efficient for fulfilling a desired function within their electronic systems.

### BRIEF DESCRIPTION OF THE DRAWINGS

Various aspects of this disclosure may be better understood upon reading the following detailed description and upon reference to examples illustrated in the drawings in which:

FIG. 1 is a block diagram of a system used to program an integrated circuit device;

FIG. 2 is a block diagram of an example integrated circuit device of FIG. 1;

FIG. 3 is a block diagram of a system architecture recommendation system;

FIG. 4 is a flowchart of a method for the system architecture recommendation system of FIG. 3 to generate a system architecture recommendation for an electronic system;

FIG. 5 is a block diagram of an application programming interface (API) gateway of FIG. 3; and

FIG. 6 is a flowchart of a method for a system, such as the system architecture recommendation system of FIG. 3, to receive integrated circuit device data from the API gateway of FIGS. 3 and 5.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

As mentioned above, identifying integrated circuit devices that may be suitable for an electronic system may be a source of challenges. As used herein, the term “electronic system” refers to any electronic device or circuitry or collection of electronic devices or circuits that includes or may be modified to include an integrated circuit device. In some cases, consumers (e.g., users, system designers) may parse hundreds or thousands of online resources to attempt to identify integrated circuit devices that may be included in an electronic system. By way of example, a consumer may seek to design or modify (e.g., upgrade) an electronic system to meet certain bandwidth specifications, latency specifications, energy use specifications, environmental impact specifications, and the like. Additionally or alternatively, the consumer may seek to design or modify the electronic system based on spatial availability within the electronic system (e.g., board fit), compliance with one or more protocols, and the like. In some cases, consumers may seek certain integrated circuit devices based on an availability of intellectual property (IP) resources that may be implemented in the electronic system (e.g., soft IP cores that may be implemented in the programmable fabric of an FPGA). For example, certain integrated circuit devices may be configured or programmed to implement certain IP cores (e.g., predefined functional blocks of circuitry) that may be obtained from various IP catalogs. More specifically, certain integrated circuit devices may implement IP cores based on a variety of factors, including hardware specifications (e.g., an amount of available programmable logic blocks), the design company that provides or manufactures the integrated circuit devices (e.g., based on an availability to access certain IP catalogs), and the like. These IP resources may be useful to consumers seeking to accelerate integrated circuit device design by reducing design costs (e.g., timing resources) for logic or circuitry that may be available in a predefined format and implementable in the electronic system. Likewise, certain integrated circuit devices may be compatible with certain drivers. Drivers may include software resources to facilitate communications between the integrated circuit device and a host device (e.g., a processor, a central processing unit (CPU), an operating system). The drivers may, for example, enable applications to run on the integrated circuit device by initializing the integrated circuit device, accelerating functions or tasks on the integrated circuit device, and managing resources (e.g., power levels, thermals) of the integrated circuit device. Certain integrated circuit devices may be compatible with certain drivers but not others (e.g., based on vendor defined toolchains and IP, communication protocols). In some cases, consumers may seek integrated circuit devices that are compatible with specific drivers.

To satisfy these demands associated with integrated circuit devices and electronic systems, the consumer may evaluate various integrated circuit devices using technical papers, product release details, and other available sources. For example, the consumer may parse and scrape web pages and online documentation (e.g., portable document format (PDF) files) to attempt to identify integrated circuit devices and their respective compatibilities with an electronic systems. In some cases, the consumer may have to coordinate with internal sources (e.g., system design engineers) to determine an impact that certain integrated circuit devices may have on the electronic system. Likewise, the consumer may have to coordinate with external sources to determine an availability of an integrated circuit device and its compatibility with the architecture of the electronic system (e.g., based on confidential or otherwise publicly unavailable details related to the integrated circuit device). For at least these reasons, it may be difficult for a consumer to determine which integrated circuit devices are compatible with the architecture of their electronic system and which integrated circuit devices enable the electronic system to operate at a desired level (e.g., according to the consumer's demands). More specifically, it may be difficult for consumers that may lack domain knowledge related to the complexities of integrated circuit devices to parse the significant amount of available information, evaluate the available information in view of their intended performance specifications, and identify one or more integrated circuit devices to be included in the electronic system. As a result, current techniques and systems for identifying and selecting integrated circuit devices to be included in electronic systems may be a source of timing and resource costs, which may in turn negatively impact electronic system development and innovation, burden internal and external resources with repetitive requests, and limit a self-service ability to build and improve electronic systems.

The present disclosure addresses these deficiencies by providing a system architecture recommendation system for generating tailored system architecture recommendations for an electronic system. More specifically, the system architecture recommendation system may include one or more artificial intelligence (AI) models, such as large language models (LLMs), for receiving plain language inputs from a client device and generating system architecture recommendations for an electronic system that is described by or associated with the client device. For example, the system architecture recommendation system may generate one or more system architecture recommendations related to integrated circuit devices that may be implemented in the electronic system. The plain language inputs may include, for example, descriptions of one or more desired specifications for the electronic system and/or an integrated circuit device to be included in the electronic system. The system architecture recommendation system may receive the user inputs and respond to the user inputs by querying the client device for additional information. For example, the system architecture recommendation system may transmit structured questions (e.g., hierarchical questions) to the client device to prompt the client device to provide information regarding the desired specifications, descriptions of the electronic system that the integrated circuit device may be implement in, and the like. The system architecture recommendation system may also query the client device for context related to existing electronic systems, domain knowledge associated with a user of the client device, and the like. In some embodiments, the system architecture recommendation system may extract context related to the electronic system from metadata associated with the client device and/or cloud data sources storing information about the client device. After determining the desired specifications of the electronic system and the context associated with the electronic system, the system architecture recommendation system may query one or more data structures (e.g., through an application programming interface (API) gateway as discussed throughout this disclosure) to receive current information regarding the availabilities of potential integrated circuit devices, the specifications of the potential integrated circuit devices, common uses or functionalities of the potential integrated circuit devices, and the like. Specifically, the system architecture recommendation system may receive (e.g., retrieve, extract) data and/or metadata about the potential integrated circuit devices based on the received inputs. Thus, in some embodiments, the system architecture recommendation system may retrieve information about potential integrated circuit devices from the one or more data structures in a time-efficient manner based on the received inputs. As a result, the system architecture recommendation system may provide timing and efficiency improvements (e.g., a resource or processing power improvement) over prior techniques that may generically parse available sources (e.g., the Internet). Indeed, the system architecture recommendation system may receive information about the potential integrated circuit devices that may be current (e.g., up to date), authenticated (e.g., from reliable sources), and tailored to the received inputs (e.g., the specifications received from the client device).

The system architecture recommendation system may then generate and transmit a system architecture recommendation to the client device based on the set of potential integrated circuit devices and the information gleaned about the electronic system. The system architecture recommendation may include, for example, a plain language response that may include an explanation, images or videos, audio outputs (e.g., text-to-speech outputs), sales resources (e.g., purchase order links), and the like. By way of example, in one case, the system architecture recommendation system may receive a question about designing an electronic system around a specific integrated circuit device. In response, the system architecture recommendation system may confirm the efficacy of the proposed system design, explain why the proposed system design may be undesirable, and/or the provide alternative integrated circuit devices or implementations that may provide improvements over the proposed system design. In another example, the received inputs many include a question about updating an electronic system without any additional insights (e.g., a specified type of integrated circuit device, a proposed system design). In response, the system architecture recommendation system may provide multiple options for implementing the electronic system using multiple types of integrated circuit devices, including associated costs, expected performance, and the like. In these ways, the system architecture recommendation system may generate timely and resource efficient system architecture recommendations that may be based on the demands of an electronic system.

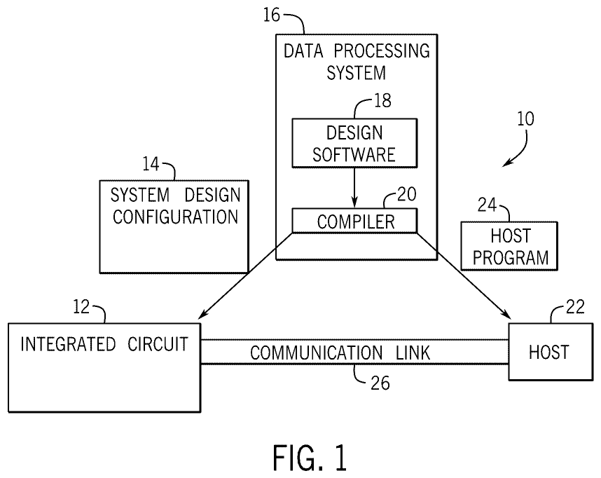

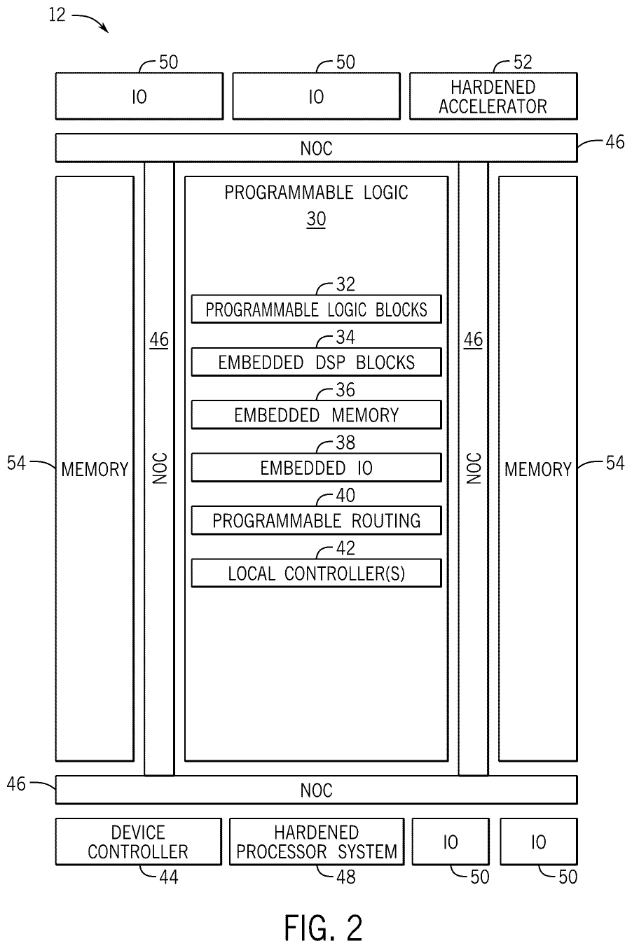

By way of background, FIGS. 1 and 2 introduce integrated circuit devices and describe some of the complexities that may be associated with integrated circuit devices, which highlight the need for the disclosed system architecture recommendation system. Thus, with the foregoing in mind, FIG. 1 illustrates a block diagram of a system 10 that may be used to program an integrated circuit device 12, such as an FPGA (e.g., Agilex™, Stratix®, Arria®, MAX®, or Cyclone® devices by Altera® Corporation), with such a system design using a system design configuration 14. Note that, while this disclosure largely refers to the integrated circuit device 12 as being a programmable logic device, such as an FPGA, in some embodiments, the integrated circuit device 12 may also include a one-time programmable device or structured application specific integrated circuit (ASIC), such as an Intel® eASIC™ device by Intel® Corporation. In other examples, the integrated circuit device 12 may be any suitable integrated circuit that is manufactured to have a particular system design with circuitry to perform desired data processing operations. The integrated circuit device 12 may be a single monolithic integrated circuit or a multi-die system of integrated circuits. The integrated circuit device 12 may include a single integrated circuit, multiple integrated circuits in a package, or multiple integrated circuits in multiple packages communicating remotely (e.g., via wires, via traces) and may be referred to as an integrated circuit device or an integrated circuit system whether formed from a single integrated circuit or multiple integrated circuits in a package.

A designer may desire to implement the system design 14 (sometimes referred to as a circuit design or configuration) to perform a wide variety of possible operations on the integrated circuit device 12. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

In a configuration mode of the integrated circuit device 12, a designer may use a data processing system 16 (e.g., a computer including a data processing system having a processor and memory or storage) to implement high-level designs (e.g., a system user design) using design software 18 (e.g., executable instructions stored in a tangible, non-transitory, computer-readable medium such as the memory or storage of the data processing system 16), such as a version of Altera® Quartus® by Altera Corporation. The data processing system 16 may use the design software 18 and a compiler 20 to convert the high-level program into a lower-level description (e.g., a configuration program, a bitstream) as the system design configuration 14. The compiler 20 may provide machine-readable instructions representative of the high-level program to a host 22 and the system design configuration 14 to the integrated circuit device 12. As will be discussed in more detail below, the system design configuration 14 may include an application program that may be associated with one or more functions. In particular, the application program may be configured to run the one or more functions on the data processing system 16. For example, the data processing system 16 may execute the application program.

Additionally or alternatively, the host 22 running the host program 24 may control or implement the system design configuration 14 onto the integrated circuit device 12. For example, the host 22 may communicate instructions from the host program 24 to the integrated circuit device 12 via a communications link 26 that may include, for example, direct memory access (DMA) communications or peripheral component interconnect express (PCIe) communications. The designer may use the design software 18 to generate and/or to specify a low-level program, using low-level tools such as the low-level hardware description languages described above. Further, in some embodiments, the system 10 may be implemented without a separate host 22 or host program 24. Thus, embodiments described herein are intended to be illustrative and not limiting.

The integrated circuit device 12 may take any suitable form that may implement the system design configuration 14. In one example shown in FIG. 2, the integrated circuit device 12 may include programmable logic circuitry 30, which may include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any of the programmable logic blocks 32 to implement any desired logic circuitry when configured with the system design configuration 14. The programmable logic blocks 32 and are sometimes referred to as logic array blocks (LABs) or configurable logic blocks (CLBs).

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may be programmed into the programmable logic blocks 32 to perform the same functions, but which may not be as efficient as the hardened circuits of the DSP blocks 34. The embedded memory blocks 36 may include dedicated local memory (e.g., blocks of 20 kB, blocks of 1 MB). The embedded IO blocks 38 may allow for inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic circuitry 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic circuitry 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic circuitry 30 of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic circuitry 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally, or alternatively, the device controller 44 may include a hardware finite state machine (FSM). The device controller 44 may provide other functions, such as serving as a platform for virtual machines that may manage the operation of the integrated circuit device 12.

A network-on-chip (NOC) 46 may connect the various elements of the integrated circuit device 12. The NOC 46 may provide rapid, packetized communication to and from the programmable logic circuitry 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic circuitry 30.

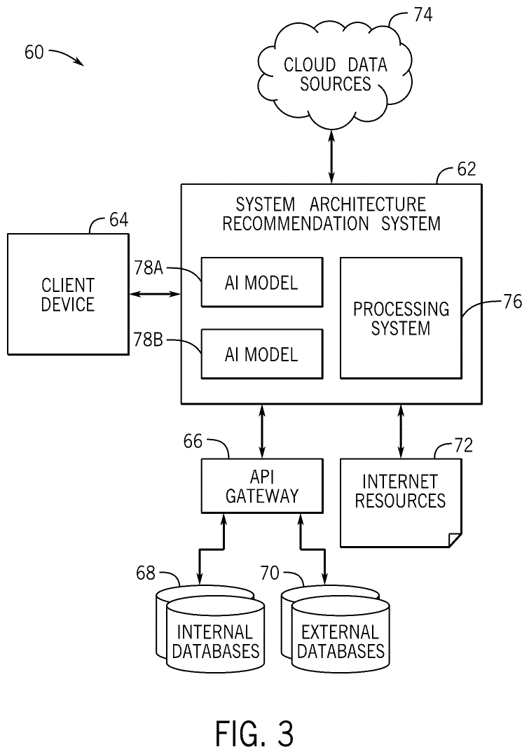

Indeed, as described above, integrated circuit devices 12 may include certain complexities that may create challenges for those seeking to use integrated circuit devices 12 in an electronic system. The present disclosure addresses these complexities by providing the system architecture recommendation system, which may reduce the complexities associated with users identifying integrated circuit devices 12 that may be suitable for a particular electronic system. With this in mind, FIG. 3 is a block diagram 60 of the system architecture recommendation system 62. More specifically, the block diagram 60 includes a communicative system between the system architecture recommendation system 62, a client device 64, an application programming interface (API) gateway 66, internal databases 68, external databases 70, internet resources 72, and cloud data sources 74. The system architecture recommendation system 62 may be communicatively coupled to any of these components to transmit and receive data. For example, the system architecture recommendation system 62 may receive inputs from the client device 64 and respond with questions (e.g., follow-up questions based on the received inputs) and/or a system architecture recommendation. The system architecture recommendation system 62 may generate the system architecture recommendation based on information that may be received or retrieved from the internal databases 68 and the external databases 70 via the API gateway 66. Likewise, the system architecture recommendation system 62 may generate the system architecture recommendation based on information received or retrieved from the internet resources 72 and the cloud data sources 74. Initially, it is worth describing each of these components and how they may interact with the system architecture recommendation system 62.

The client device 64 may be any suitable electronic device that may communicate data with the system architecture recommendation system 62. By way of example, the client device 64 may be or may include a smart phone, a laptop, a desktop, a tablet, or the like. The client device 64 may include various components for communicating with the system architecture recommendation system 62, such as a processor, storage, memory, a display, and the like. In some embodiments, multiple client devices 64 may communicate with the system architecture recommendation system 62 consecutively or concurrently.

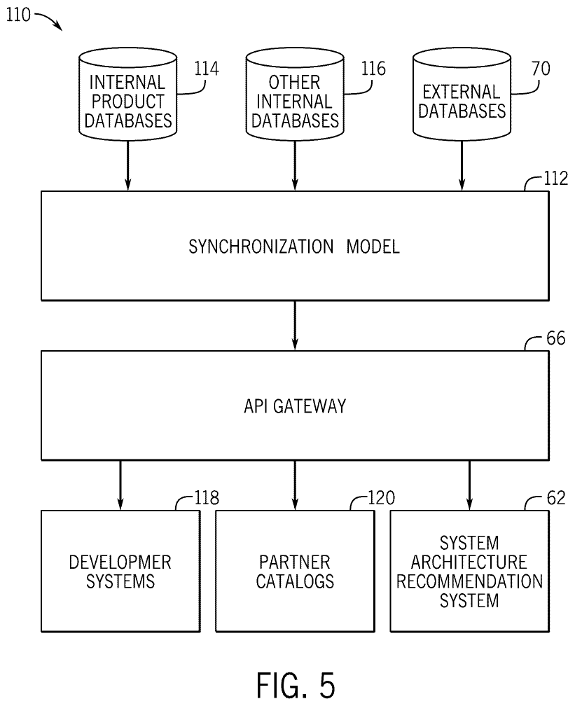

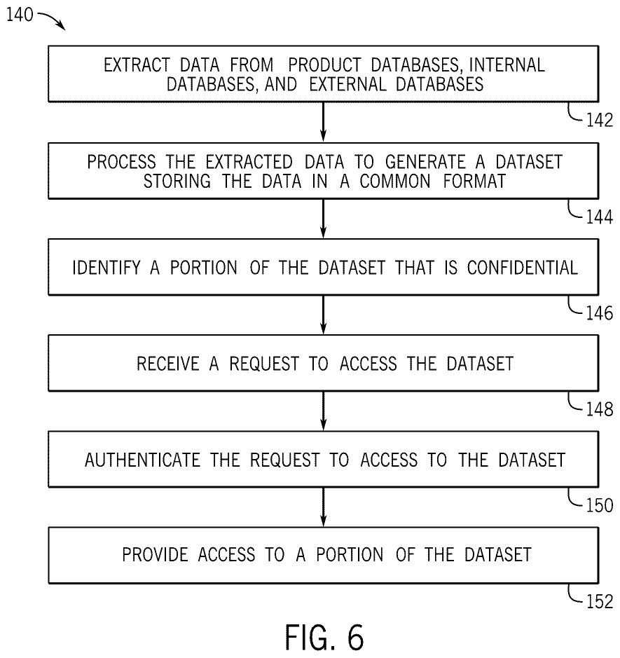

The system architecture recommendation system 62 may use various data sources for generating the system architecture recommendations. For example, in some embodiments, the system architecture recommendation system 62 may communicate with the internal databases 68 and the external databases 70 via the API gateway 66 (e.g., a server or computing service). Additionally or alternatively, the system architecture recommendation system 62 may communicate directly with the internal databases 68 and the external databases 70. The internal databases 68 may store data related to a particular manufacturer or brand of integrated circuit devices 12. For example, the internal databases 68 may store integrated circuit device specifications, marketing details (e.g., costs), new integrated circuit devices 12 that may be in development, troubleshooting or guidelines for using the integrated circuit devices 12, and the like. In some embodiments, the internal databases 68 may be controlled by or store integrated circuit device data relating to a developer of the system architecture recommendation system 62. Conversely, the external databases 70 may be controlled by or store integrated circuit device data related to third parties (e.g., separate development companies). The external databases 70 may include similar types or categories of data to the internal databases 68. However, it should be noted that the internal databases 68 and the external databases 70 may store different types of data in different data structure configurations. As will be discussed in more detail with reference to FIGS. 5 and 6, the API gateway 66 may receive (e.g., extract) data from the internal databases 68 and the external databases 70 and provide normalized, authenticated, and sanitized (e.g., cleaned, such that proprietary or trade secret information is excluded) integrated circuit device data to the system architecture recommendation system 62.

The system architecture recommendation system 62 may also receive (e.g., retrieve) integrated circuit device data from the internet resources 72. The internet resources 72 may refer to one or more websites that may include information about a variety of commercially available integrated circuit devices 12 and/or IP that may be implemented on the integrated circuit devices 12. Indeed, some of the information that may be publicly available on the internet resources 72 may differ from information found in the internal databases 68 or the external databases 70. To provide a few examples, the internet resources 72 may include tests or comparisons between multiple integrated circuit devices that are developed by different companies. As another example, the internet resources 72 may provide pricing information for integrated circuit devices 12 and availabilities that may not be available directly from manufacturers (e.g., from distributors or retailers). Further, the internet resource 72 may include information that may be dynamically updated, such as standard specifications, research papers, updated IP catalogs, and the like. In these ways, the internet resources may provide the system architecture recommendation system 62 with additional integrated circuit device data that may not be included in the internal databases 68 or the external databases 70.

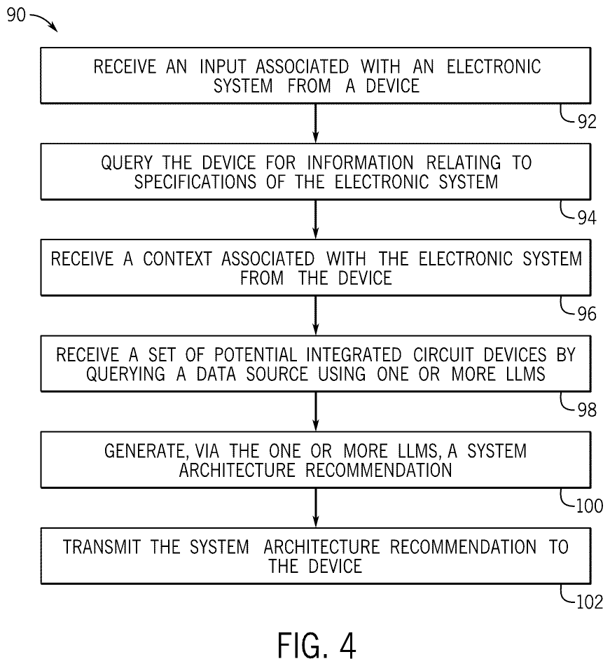

In some embodiments, the system architecture recommendation system 62 may be communicatively coupled to the cloud data sources 74. The cloud data sources 74 may refer to any suitable cloud data servers that may store data or host web applications. In some cases, the cloud data sources 74 may store data relating to the client device 64 and any electronic systems that the client device 64 may be associated with. By way of example, in previous interactions with the system architecture recommendation system 62, the client device 64 may have provided information relating to one or more electronic systems. In some cases, the client device 64 may have previously described the one or more electronic systems via the one or more inputs. The cloud data sources 74 may store information related to these interactions, including types and configurations of electronic systems that may be associated with the client device 64. As used herein, configurations of an electronic system may refer to any aspect of a design of the electronic system, including electronic components or circuitry included in the electronic system, constraints associated with the electronic system (e.g., spatial ability), roles or functions of the electronic system (e.g., data processing, communication), drivers used or available for the electronic system, IP incorporated into the electronic system, and the like. In additional or alternative embodiments, the cloud data sources 74 may be directly coupled to one or more electronic systems associated with client device 64 (e.g. via one or more APIs). For example, in the context of FPGAs, the cloud data sources 74 may include design tools and IP catalogs (e.g., design software and development tools, such as Quartus Prime® developed by Altera Corporation of San Jose, California) that may provide insights or configurations of the electronic systems utilizing the FPGAs. By way of specific example, the system architecture recommendation system 62 may retrieve data from the cloud data sources 72 indicative of IP (e.g., soft IP cores) that the electronic system has previously implemented from an IP catalog (e.g., downloaded to an FPGA). Likewise, the cloud data sources 74 may provide indications as to drivers previously used within the electronic system. In these ways, the cloud data sources 74 may store information tailored to the client device 64 (e.g., or an account associated with the client device 64) and the electronic systems associated with the client device 64. Similarly, the system architecture recommendation system 62 may identify any drives that are used in the electronic system based on information retrieved from the cloud data sources 74. The system architecture recommendation system 62 may use the information stored in the cloud data sources 74 as electronic system context for generating the system architecture recommendation. Additionally or alternatively, as will be discussed with reference to FIG. 4, the cloud data sources 74 may be used as a resource for evaluating (e.g., estimating) the effects of including a particular integrated circuit device 12 in an electronic system. For example, the system architecture recommendation system 62 may use a web application hosted on an instance of the cloud data sources 74 to simulate the effects of implementing the particular integrated circuit device 12 in the electronic system.

Turning now to the system architecture recommendation system 62, the system architecture recommendation system 62 may be or may include one or more computing devices. For example, the system architecture recommendation system 62 may include processing circuitry 76, which may control the operations of the system architecture recommendation system 62. In some embodiments, the system architecture recommendation system 62 may include a tangible, non-transitory computer readable medium that may be executed by the processing circuitry 76 to generate the system architecture recommendations described herein. Additionally or alternatively, in some embodiments, the system architecture recommendation system 62 may be implemented as a web application or in any other suitable format. In any case, the system architecture recommendation system 62 may host or access large language models (LLMs) 78A, 78B (collectively referred to as the LLMs 78). The LLMs 78 may be any suitable type of LLM (e.g., a retrieval augmented generation (RAG) model, a deep learning neural network, a support vector machine (SVM)) that may interface with the client device 64 and/or the data sources to generate the system architecture recommendation. As depicted, the system architecture recommendation system 62 may host multiple LLMs 78 that may be the same or different types of LLM. In some embodiments, for example, the system architecture recommendation system 62 may host a first LLM 78A for interfacing with the client device 64 (e.g., a front-facing LLM). The first LLM 78A may, for example, query the client device 64 for electronic system information, generate responses to the inputs received from the client device 64, translate and transmit the system architecture recommendation to the client device 64, and the like. The system architecture recommendation system 62 may also host a second LLM 78B (e.g., a backend LLM) for interfacing with the API gateway 66, the internal databases 68, the external databases 70, the internet resources 72, and/or the cloud data sources 74. In this example embodiment, the second LLM 78B may use the information that may be received from the client device 64 by the first LLM 78 to query the data sources to receive (e.g., retrieve) integrated circuit device data. In some embodiments, the second LLM 78B may identify one or more potential integrated circuit devices based on the received integrated circuit device data and generate a system architecture recommendation from the potential integrated circuit devices. The first LLM 78A may translate the system architecture recommendation into an output (e.g., a text-based description) to be transmitted to the client device 64 based on the system architecture recommendation generated by the second LLM 78B. Although two LLMs 78 are depicted in this diagram 60, the system architecture recommendation system 62 may host or access any number of LLMs 78 for communicating with the client device 64, receiving the integrated circuit device data from the data sources, and generating a system architecture recommendation.

In some embodiments, the system architecture recommendation system 62 may retrain or fine-tune the LLMs 78. For example, the system architecture recommendation system 62 may periodically (e.g., every day, every week, every month, every year) evaluate the effectiveness of the system architecture recommendations and adjust the LLMs 78 accordingly. In some cases, the system architecture recommendation system 62 may retrain or fine-tune the LLMs 78 based on user satisfaction metrics (e.g., integrated circuit device sales resulting from client device 64 interactions with the system architecture recommendation system 62), received feedback from the client devices 64, and the like. In these ways, the system architecture recommendation system 62 may periodically adjust the LLMs 78 to improve performance by generating more accurate and comprehensive system architecture recommendations.

With the foregoing in mind, FIG. 4 is a flowchart of a method 90 for the system architecture recommendation system 62 of FIG. 3 to generate a system architecture recommendation for an electronic system. Although the following description of the method 90 is described as being performed by the system architecture recommendation system 62 of FIG. 3, it should be noted that any suitable device capable of receiving and processing data may perform the method 90 described herein. In addition, although the method 90 is described in a particular order, it should be understood that the method 90 may be performed in any suitable order and may exclude one or more of the blocks described herein.

At block 92, the system architecture recommendation system 62 may receive an input associated with an electronic system from the client device 64. As mentioned above, the initial input from the client device 64 may be a question about integrated circuit devices 12, an electronic system, or the like. By way of example, the client device 12 may interface with a graphical user interface (GUI) to submit inputs to the system architecture recommendation system 62. For example, the GUI may include a textual input mechanism, such as a chat bot, a search functionality, or the like. In some embodiments, the system architecture recommendation system 62 may initially prompt the client device 64. For example, the system architecture recommendation system 62 may transmit an indication to the client device 64 of proposed improvements or technological updates to integrated circuit devices 12 included in the electronic system that is associated with the client device 64. By way of specific example, in the context of FPGAs, the system architecture recommendation system 62 may transmit an indication through a design software or FPGA development tool (e.g., Quartus Prime® developed by Altera Corporation of San Jose, California) of an improvement to an FPGA included in an electronic system associated with the client device 64. Indeed, in some embodiments, the system architecture recommendation system 62 may transmit a product change notification (PCN) in response to new integrated circuit device 12 releases that may be of interest to the client device 64 (e.g., based on improvements to current integrated circuited devices 12 used by the client, updated IP for the integrated circuit devices 12, newly released drivers that may be used with the integrated circuit devices 12). The system architecture recommendation system 62 may provide notifications of subsequent releases that identify new integrated circuit device 12 releases (e.g., updated integrated circuit device families and release versions) and any potential benefits associated with the new releases. In these ways, the system architecture recommendation system 62 may receive an input relating to an existing electronic system, a planned electronic system, an entirely new electronic system, or the like.

At block 94, the system architecture recommendation system 62 may query the client device 64 for information relating to specifications of electronic system. More specifically, the system architecture recommendation system 62 may transmit multiple queries to the client device 64 for information relating to desired specifications (e.g., bandwidth specifications, latency specifications, protocol compliance) for the electronic system and/or the integrated circuit devices to be included in the electronic system. The desired specifications may refer to both hardware specifications associated with the integrated circuit device and IP that may be implemented on the integrated circuit device (e.g., based on an availability of programmable logic blocks 32 within the integrated circuit device 12, an access or compatibility with IP cores associated with specific integrated circuit device 12). In some embodiments, the system architecture recommendation system 62 may use an LLM 78 (e.g., the first front-facing LLM 78A described with reference to FIG. 3) to receive the inputs from the client device 64 and extract additional information from the client device 64 by generating and transmitting follow-up queries to the client device 64. In some embodiments, the system architecture recommendation system 62 may use a hierarchical approach for querying the client device 64. For example, the system architecture recommendation system 62 may send initial messages that broadly request information about the electronic system. Then, as the system architecture recommendation system 62 receives inputs from the client device 64, the system architecture recommendation system 62 may tailor the scope of the queries based on responses from the client device 64 and the desired specifications for the electronic system and/or integrated circuit device 12 to be included in the electronic system. By way of specific example, the first input (block 92) may request an integrated circuit device 12 recommendation that may be used to expand a particular electronic system. The system architecture recommendation system 62 may then query the client device 64 by requesting data related to bandwidth specifications (I/O bandwidth specifications) and requested protocol compatibility (e.g., Peripheral Component Interconnect Express (PCIe) Gen4 8x, Low-Voltage Differential Signaling (LVDS)). After receiving a second input from the client device 64 that provides responses to this query, the system architecture recommendation system 62 may query the client device for data related to physical demands of the integrated circuit device 12, such as physical dimensions and specifications, package types, the like (e.g., a desired full height, a half-length, whether the integrated circuit device 12 will be implemented on a custom board size, Quad Small Form Factor Pluggable Double Density (QSFP-DD) compatibility). After receiving these responses, the system architecture recommendation system 62 may then query the client device 64 for constraints associated with the electronic system. For example, the system architecture recommendation system 62 may query the client device for desired temperature ranges, industrial requirements, hard processor system (UPS) demands, or the like. Further, based on the client devices' 64 responses to these queries, the system architecture recommendation system 62 may query the client device 64 for design specifications, such as a desire to implement particular IP cores available across catalogs (e.g., vendor-specific IP catalogs, open source IP core libraries, custom IP cores created by a design team associated with the electronic system), an ability to operate or train AI models, Fast Fourier Transform (FFT) sizes (e.g., frequency resolutions and spectral line demands), operable codec types, and the like. As demonstrated, the system architecture recommendation system 62 may query the client device for a variety of different specifications and constraints that may fall under a number of different categories (e.g., bandwidth specifications and protocol configurations of the integrated circuit device 12, physical demands of the integrated circuit 12, specifications or constraints of the electronic system, design specifications). It should be noted that these categories and the example queries within each category are only intended to provide a few examples cases. Indeed, the system architecture recommendation system 62 may query the client device 64 with any suitable questions related to the integrated circuit device 12 and/or electronic system.

At block 96, the system architecture recommendation system 62 may receive a context associated with the electronic system. The context may refer to a configuration of an electronic system or broader environment that the integrated circuit device will be used in. In some embodiments, the system architecture recommendation system 62 may receive at least part of the context associated with the electronic system as part of the process of querying the client device 64 (block 94). Additionally or alternatively, the system architecture recommendation system 62 may receive information associated with an existing electronic system from metadata associated with the client device 64 and/or from cloud data sources 74 that may store information relating to the electronic system. By way of example, the system architecture recommendation system 62 may extract metadata from the client device 64 to determine a current configuration of an existing electronic system associated with the client device 64 (e.g., based on past interactions between the client device 64 and the system architecture recommendation engine 62, such as IP that the client device 12 has downloaded or otherwise implemented from the cloud data sources 74), a previous configuration of an electronic system associated with the client device 64, or the like. The system architecture recommendation system 62 may, for example, extract an internet protocol (IP) address of the client device 64 which may be associated with one or more electronic systems. Additionally or alternatively, as described above, the cloud data sources 74 may include development tools or other resources that may be associated with the electronic systems of the client device 64. In some embodiments, the system architecture recommendation system 62 may utilize data stored in the cloud data sources 74 to determine the context (e.g., the configurations of the electronic sources). In these ways, the system architecture recommendation system 62 may identify desired specifications of the electronic system and/or integrated circuit device to be included in the electronic system (block 94) and determine context associated with the electronic system. As a result, the system architecture recommendation system 62 may generate system architecture recommendations that are tailored to a configuration of a particular electronic system associated with the client device 64.

Further, in some embodiments, the system architecture recommendation system 62 may receive contextual information associated with a user of the client device 64 (e.g., or an account associated with the client device 64) from metadata associated with the client device 64 and/or the cloud data sources 74. The system architecture recommendation system 62 may, for example, determine a level of domain knowledge associated with the client device 64 based on a history of interactions between the client device 64 and the system architecture recommendation system 62. In some embodiments, the system architecture recommendation system 62 may use the level of domain knowledge to generate system architecture recommendations that may be suitable for the skill level of a user associated with the client device 64 (e.g., providing more information or less complex recommendations for inexperienced users, providing complex technical details for repeat users).

Turning to block 98, the system architecture recommendation system 62 may receive a set of potential integrated circuit devices by querying data sources using one or more LLMs 78. More specifically, the system architecture recommendation system may provide the specifications for the electronic system and/or integrated circuit device 12 and the context associated with the electronic system to an LLM 78 (e.g., the backend LLM 78B described with reference to FIG. 3). The LLM 78 may then query data sources to retrieve integrated circuit device data. The LLM 78 may use the retrieved integrated circuit device data to generate a set of potential integrated circuit devices 12 that may, for example, be included in a new electronic system or be implemented in an existing electronic system. By way of example, the LLM 78 may query the API gateway 66 to retrieve information from the internal databases 68 and the external databases 70. Likewise, the LLM 78 may query the internet resources for supplemental context that may not be found from the API gateway 66. The LLM 78 may then classify the retrieved data and identify a set of potential integrated circuit devices from the retrieved data that may be included in the electronic system. In these ways, the LLM 78 may receive a set of potential integrated circuit devices 12 that may be responsive to user demands and a configuration of a particular electronic system.

At block 100, the system architecture recommendation system 62 may generate, via the one or more LLMs 78, a system architecture recommendation. The system architecture recommendation may include at least one potential integrate circuit device 12 of the set of potential integrated circuit devices 12. More specifically, the one or more LLMs 78 (e.g., the front-facing LLM 78A described with reference to FIG. 3) may generate the system architecture recommendation based on the desired specifications of the electronic system and/or the integrated circuit device 12 to be included in the electronic system and the context associated with the electronic system. More broadly, the system architecture recommendation may include one or more integrated circuit device 12 that may be responsive to the received inputs from the client device 12 and the system parameters of the electronic system. In some embodiments, the system architecture recommendation may include multiple possible implementations of the integrated circuit device 12 within the electronic system, the expected performance of the integrated circuit device 12 within the electronic system, technical effects of implementing the integrated circuit device 12 in the electronic system, or the like.

In some embodiments, the system architecture recommendation system 62 may use the one or more LLMs 78 to determine the expected effects (e.g., the expected performance) of including the potential integrated circuit devices 12 in the electronic system. For example, the system architecture recommendation system 62 may use a virtual instance in the cloud data sources 74 to simulate including the potential integrated circuit devices 12 in the electronic system. As mentioned above, the cloud data source 74 may store a configuration of the electronic system. Thus, the system architecture recommendation system 62 may use the LLMs 78 (e.g., the backend LLM 78B) to test the set of potential integrated circuit devices 12 based on a virtual configuration of electronic system. As a result, the LLMs 78 may generate compatibility metrics (e.g., one or more test results) to compare the performance of each integrated circuit device 12 of the potential integrated circuit devices 12. The compatibility metrics may refer to a performance of the electronic system when the integrated circuit devices 12 are included in or implemented in the electronic system. By way of example, the compatibility metrics may include a predicted latency of the electronic system, a predicted bandwidth of the electronic system, a predicted amount of processing resources used by the electronic system, a predicted spatial usage of the integrated circuit device 12 within the electronic system, and the like. These examples are intended to demonstrate that the compatibility metrics may be performance indications based on or derived from the electronic system and/or integrated circuit device specifications that may be received by the system architecture recommendation system 62. The system architecture recommendation system 62 may generate the system architecture recommendation based on at least one potential integrated circuit device of the set of potential integrated circuit devices that the metrics indicate satisfy the electronic system specifications (e.g., based on the received inputs by the client device 64). Moreover, the system architecture recommendation system 62 may generate the system architecture recommendation that may include expected performance benefits or drawbacks of implementing the at least one potential integrated circuit devices in the electronic system based on the metrics generated by the LLMs 78.

At block 102, the system architecture recommendation system 62 may transmit the system architecture recommendation to the client device 64. In some embodiments, the system architecture recommendation system 62 may transmit detailed recommendations of integrated circuit devices 12 or integrated circuit device parts. The system architecture recommendation system 62 may also transmit additional information, such as, a thermal envelop of the integrated circuit device 12 (e.g., a maximum amount of power or heat associated with the integrated circuit device 12), electronic system estimates associated with implementing the integrated circuit device 12 (e.g., based on the compatibility metrics discussed with reference to block 100), commercial availabilities and costs, and the like. In these ways, the system architecture recommendation system 62 may generate a detailed system architecture recommendation that is responsive to the received inputs from the client device 64, which may provide a particular improvement in time and resource efficiency in the complex field of integrated circuit devices 12.

With the preceding in mind, FIG. 5 is a block diagram 110 of the API gateway 66 of FIG. 3. As mentioned above, the API gateway 66 may be a server or computing service that may provide a benefit related to retrieving or providing the system architecture recommendation system 62 with access to current data about integrated circuit devices 12. More specifically, the API gateway 66 may provide the system architecture recommendation system 62 with integrated circuit device data from the internal databases 68 and the external databases 70. In some embodiments, the API gateway 66 may be a Representational State Transfer (REST) API that may include a set of constraints for communications between a client (e.g., the client device 64, the system architecture recommendation model 112) and the internal databases 68 and external databases 70. To facilitate this transfer of data, in some embodiments, the API gateway 66 may be communicatively coupled to a synchronization model 112. Additionally or alternatively, the synchronization model 112 may be included in the API gateway 66. As will be discussed in more detail, the synchronization model 112 may be communicatively coupled to internal product databases 114, other internal databases 116, and the external databases 70.

The internal product databases 114 and the other internal databases 116 may be included in the internal databases 68 of FIG. 3. The internal product databases 114 may, for example, store integrated circuit device specifications, configurations, programming details (e.g., in the case of FPGAs), and the like. For example, the internal product databases 114 may store IP catalogs that may include predefined logic or circuitry that may be implemented in the soft logic of certain integrated devices 12 (e.g., using design software). The internal product databases 114 may also store design software and/or drivers that may be used to control and implement functions on the integrated circuit devices 12. Further, the internal product databases 114 may include costs associated with the integrated circuit devices 12, availabilities of the integrated circuit devices 12, and the like. In some cases, the internal product databases 114 may include confidential data (e.g., proprietary data, trade secrets) relating to the integrated circuit devices 12, such as in-development or otherwise unreleased integrated circuit devices 12. The other internal databases 116 may include other information associated with the internal circuit devices, common electronic system configurations, and the like. For example, in some embodiments, the other internal databases 116 may include customer information such as sales trends, customer-specific data associated with the client device 64 (e.g., previous integrated circuit device 12 purchases or searches), and the like. The internal product databases 114 and the other internal databases 116 may be hosted by the same integrated circuit device manufacturer that develops or hosts the public API gateway 66. As a result, the public API gateway 66, the internal product databases 114 and the other internal databases 116 may be viewed as first party data sources or devices. The synchronization model 112 may also be communicatively coupled to the external databases 70. As mentioned above, the external databases 70 may store data that may be similar to the internal product databases 114 and/or the other internal databases 116. However, the external databases 70 may be associated with different integrated circuit device development and manufacturing companies (e.g., vendor-specific IP catalogs hosted by external development and manufacturing companies, drivers and software toolchains provided by external development and manufacturing companies). As a result, the external databases 70 may be viewed as third party data sources or devices. In these ways, the synchronization model 112 may have access to a wide portfolio of integrated circuit devices 12 that may include data from both internal and external sources.

Returning back to the description of the synchronization model 112, the synchronization model 112 may be any suitable model (e.g., an AI model, such as an LLM) that may receive integrated circuit device data from data sources. For example, the synchronization model 112 may retrieve, extract, or pull integrated circuit device data from internal product databases 114, the other internal databases 116, and/or the external databases 170 (collectively referred to as the data sources). The synchronization model 112 may then transform (e.g., synthesize, reformat) the integrated circuit device data to store the integrated circuit device data from the data sources in a common format. More specifically, the synchronization model 112 may transform the integrated circuit device data into a format that may be accessible to the system architecture recommendation system 62 (e.g., the backend LLM 78B of the system architecture recommendation system 62). In some embodiments, the synchronization model 112 may identify confidential information that is retrieved from the data sources and sanitize or clean the data, such that the confidential information may not be publicly disclosed.

Turning to the API gateway 66, the API gateway 66 may be communicatively coupled to the synchronization model 112 and one or more systems or devices that may pull the integrated circuit device data from the API gateway 66. By way of example, developer systems 118 may be coupled to the API gateway 66 to enable electronic system developers to directly access integrated circuit device data. For example, in cases where a developer may have previously purchased integrated circuit devices 12 based on a system architecture recommendation from the system architecture recommendation system 62, the developers may seek to look up information about the integrated circuit device 12 (e.g., protocol compatibility, various specifications, available IP cores) to confirm that the integrated circuit device 12 can be used for a particular purpose. Likewise, the API gateway 66 may be coupled to partner catalogs 120. The partner catalogs 120 may refer to distributors or retailers that may market and sell integrated circuit devices. In this way, the API gateway 66 may be used to provide partner catalogs 120 with current (e.g., up to date) information about integrated circuit device 12 releases, availabilities, and the like. Additionally or alternatively, the system architecture recommendation system 62 may access the API gateway 66 as part of a process for generating a system architecture recommendation for the client device 64.

In some embodiments, the API gateway 66 may demand authentication before providing access to the integrated circuit device data. For example, the API gateway 66 may use a multi-level authentication scheme to provide certain systems access whereas others may be prevented from receiving similar access. By way of specific example, certain partner catalogs 120 may be restricted from viewing confidential integrated circuit device data related to integrated circuit devices that may be in development. However, the system architecture recommendation system 62 may have access to some confidential integrated circuit device data. For example, if technical details related to a new FPGA are not released, but such an FPGA would provide a benefit in a certain electronic system for the client device 64, the system architecture recommendation system 62 may access certain details about the new FPGA (e.g., a product name, a release date). In this example, the system architecture recommendation system 62 may indicate to the client device 64 that a new product may satisfy or fulfill the demands of the electronic system associated with the client device 64 and provide the client device with further instructions (e.g., contacting a sales representative, preordering the unreleased new product). In these ways, the API gateway 66 may limit access to the integrated circuit device data based on a multi-level authentication framework to limit any risk of unintentionally releasing confidential information.

With the foregoing mind, FIG. 6 is a flowchart of a method 140 for a system, such as the system architecture recommendation system 62, to receive integrated circuit device data from API gateway 66. Although the following description of the method 140 is described as being performed by the synchronization model 112 and the API gateway 66 of FIG. 5, it should be noted that any suitable device or devices capable of receiving and processing data may perform the method 140 described herein. In addition, although the method 140 is described in a particular order, it should be understood that the method 140 may be performed in any suitable order and may exclude one or more of the blocks described herein.

At block 142, the synchronization model 112 may extract data from internal product databases 114, other internal databases 116, and the external databases 70. The synchronization model 112 may periodically (e.g., every ten minutes, every hour, every two days, or so on) extract data from these data sources at any suitable time increment. In some embodiments, the synchronization model 112 may continually parse the data sources to determine if there are any updates or changes to the integrated circuit device data. Further the synchronization model may pull data from the data sources based on a received request to access a portion of the dataset (block 148). The synchronization model 112 may extract any data related to integrated circuit devices 12, including their specifications, costs, and the like,

At block 144, the synchronization model 112 may process the extracted data to generate a dataset that stores the integrated circuit device data in a common format. As mentioned above, the integrated circuit device data may be stored by the data sources in a variety of formats (e.g., in different data structures, using different naming conventions). The synchronization model 112 may reformat the data so that it may be stored in a structured hierarchy that is easily accessible to the system architecture recommendation system 62, the developer systems 118, and/or the partner catalogs 120.

At block 146, the synchronization model 112 may identify a portion of the dataset that includes confidential data. As mentioned above, the synchronization model 112 may retrieve confidential integrated circuit device data from the data sources. Thus, the synchronization model may identify any retrieved data that may be confidential or otherwise publicly unavailable. In some cases, the retrieved data may be confidential with respect to some requesters but not other requesters. To provide another example, certain integrated devices 12 may be exclusively licensed to specific distributors, and, therefore, the corresponding integrated circuit device data may be accessible by certain partner catalogs 120 but not others. Accordingly, the synchronization model 112 classify different portions of the dataset based on whether the data is confidential and whether any systems or requesters may have access to the confidential data.

At block 148, the API gateway 66 may receive a request to access the dataset. For example, the API gateway 66 may receive a request to access the dataset from the system architecture recommendation system 62. The system architecture recommendation system 62 may transmit a data query to the API gateway 66 to retrieve a portion of the dataset. By way of example, if the system architecture recommendation system 62 receives a request from the client device 64 for data regarding FPGAs that are compatible with PCIe communications, the system architecture recommendation system 62 may query the API gateway 66 to retrieve a set of PCIe compatible FPGAs that may be implemented in an electronic system associated with the client device 64.

At block 150, the API gateway 66 may authenticate the request to the access the dataset. Put differently, the API gateway may determine that the device or system requesting access to the dataset has access privileges to access the dataset and/or the portions of the dataset that the device or system is attempting to access. As mentioned above, certain portions of the dataset may be confidential based on various access permissions. Thus, the API gateway 66 may determine whether the requester has access to all of the data that is requested or only a portion of the data that is requested. In this way, the API gateway 66 may limit the unintentional release of confidential integrated circuit device data stored in the data sources.

At block 152, the API gateway 66 may provide access to a portion of the dataset. As many be appreciated the API gateway 66 may provide various benefits for the developer systems 118, the partner catalogs 120, and the system architecture recommendation system 62. To provide a few examples, the API gateway 66 may increase timing and resource efficiencies by providing one unified integrated circuit device 12 portfolio that includes integrated circuit device data stemming from various internal and external data sources. Moreover, the API gateway 66 may provide access to the integrated circuit device data in a common format, such that the systems requesting access to the data may utilize generally applicable search queries to access any integrated circuit device data stored within the dataset. In these ways, the API gateway 66 may provide a time efficient resource for accessing current data related to integrated circuit devices 12 without demanding significant computing resources for gathering and parsing multiple data sources.

Technical effects of the disclosed embodiments provide systems and methods for generating system architecture recommendations that are tailored to user demands and particular electronic systems. The disclosed embodiments provide techniques for responding to user queries about including integrated circuit devices in electronic systems by generating recommendations that are tailored to the users' electronic systems and satisfy any specifications requested by the user. Moreover, the disclosed embodiments include techniques for limiting the timing and computational resources that may typically be used to generate such recommendations by utilizing cloud data source 74 to extract information (e.g., configurations) of existing electronic systems and an API gateway 66 to extract, synthesize, and clean integrated circuit device data. In these ways, the disclosed embodiments provide a measurable benefit in the technical fields of electronic system design and integrated circuit identification and implementation.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. A system comprising:
a client device; and
an application programming interface (API) gateway device configured to provide access to integrated circuit device data to the client device using operations comprising:
   receiving a request to access a portion of integrated circuit device data from the client device;
   determining that the client device has access privileges to the requested portion of integrated circuit device data;
   retrieving the requested portion of integrated circuit device data from a plurality of databases; and
   providing the client device with access to the requested portion of integrated circuit device data.

EXAMPLE EMBODIMENT 2. The system of example embodiment 1, wherein the API gateway device is configured to:
generate a dataset by transforming the requested portion of integrated circuit device data retrieved from the plurality of databases into a common format;
determine that the dataset comprises confidential data; and
remove the confidential data from the dataset before providing the client device with access to the requested portion of integrated circuit device data.

EXAMPLE EMBODIMENT 3. The system of example embodiment 1, wherein the integrated circuit device data comprises an availability of an integrated circuit device, a cost of the integrated circuit device, a protocol compatibility of the integrated circuit device, one or more intellectual property (IP) cores associated with the integrated circuit device, a driver compatibility with the integrated circuit device, or any combination thereof.

EXAMPLE EMBODIMENT 4. The system of example embodiment 1, wherein the client device comprises a system architecture recommendation system that is configured to generate an integrated circuit device recommendation based on a received target specification.

EXAMPLE EMBODIMENT 5. The system of example embodiment 4, wherein the system architecture recommendation system is configured to access a large language model (LLM), the LLM being configured to generate the requested portion of integrated circuit device data based on the received target specification and query the API gateway device for the requested portion of integrated circuit device data.

EXAMPLE EMBODIMENT 6. The system of example embodiment 4, wherein the integrated circuit device recommendation comprises a comparison between at least two integrated circuit devices.

EXAMPLE EMBODIMENT 7. The system of example embodiment 4, wherein the plurality of databases are associated with multiple integrated circuit device manufacturers, the multiple integrated circuit device manufactures comprising a first party integrated circuit device manufacturer and a third party integrated circuit device manufacturer, wherein the first party integrated circuit device manufacturer hosts the API gateway device.

EXAMPLE EMBODIMENT 8. The system of example embodiment 7, wherein the system architecture recommendation system is configured to generate a compatibility metric for an integrated circuit device associated with the integrated circuit device recommendation, the compatibility metric comprising an expected performance of the integrated circuit device in the existing electronic system.

EXAMPLE EMBODIMENT 9. The system of example embodiment 1, wherein at least one database of the plurality of databases comprises an intellectual property (IP) catalog comprising IP cores to be implemented in field programmable gate arrays (FPGAs).

EXAMPLE EMBODIMENT 10. A method comprising:
receiving one or more target specifications for an integrated circuit device;
accessing integrated circuit device data via an application programming (API) gateway, the API gateway comprising a communicative connection to a plurality of external databases comprising integrated circuit device specifications; and
retrieving a set of data from the integrated circuit device data based on the one or more target specifications.

EXAMPLE EMBODIMENT 11. The method of example embodiment 10, comprising:
identifying, via a system architecture recommendation system, a recommendation for an integrated circuit device based on the set of data and the one or more target specifications; and
transmitting the recommendation to a client device.

EXAMPLE EMBODIMENT 12. The method of example embodiment 11, wherein the system architecture recommendation system comprises one or more large language models (LLMs) configured to query the API gateway to retrieve the set of data based on the one or more target specifications.

EXAMPLE EMBODIMENT 13. The method of example embodiment 11, comprising: identifying an electronic system associated with the client device based on metadata associated with a client device, a cloud data structure comprising data associated with the client device, or any combination thereof, wherein the recommendation is further based on the electronic system.

EXAMPLE EMBODIMENT 14. The method of example embodiment 10, wherein the target specifications comprise a protocol compatibility of the integrated circuit device, one or more intellectual property (IP) cores associated with the integrated circuit device, a driver compatibility with the integrated circuit device, or any combination thereof.

EXAMPLE EMBODIMENT 15. The method of example embodiment 10, comprising transmitting an indication of an integrated circuit device product release or integrated circuit device product update to a client device based on integrated circuit device data.

EXAMPLE EMBODIMENT 16. A non-transitory, computer-readable medium, comprising computer-readable instructions that, when executed by one or more processors of one or more computers, cause the one or more computers to:
receive a plain language request for integrated circuit device data;
query multiple data sources via an application programming interface (API) gateway to retrieve the integrated circuit device data based on the plain language request, the multiple data sources comprising internal integrated circuit device databases and external integrated circuit device data; and
generate a dataset based on a portion of the retrieved integrated circuit device data that is responsive to the plain language request.

EXAMPLE EMBODIMENT 17. The non-transitory, computer-readable medium of example embodiment 16, wherein the integrated circuit device data comprises multiple intellectual property (IP) core catalogs associated with multiple integrated circuit device vendors.

EXAMPLE EMBODIMENT 18. The non-transitory, computer-readable medium of example embodiment 16, wherein the computer-readable instructions cause the one or more computers to:
parse the multiple data sources to identify a change in the integrated circuit device data indicating a product release or update; and
transmit an indication to a client device based on the change in the integrated circuit device data indicating the product release or update.

EXAMPLE EMBODIMENT 19. The non-transitory, computer-readable medium of example embodiment 16, wherein the plain language request for integrated circuit device data is received from a client device, and the computer-readable instructions cause the one or more computers to:
identify an existing electronic system associated with the client device; and
generate a system architecture recommendation for the client device based on the dataset and the existing electronic system, the system architecture recommendation comprising at least one integrated circuit device.

EXAMPLE EMBODIMENT 20. The non-transitory, computer-readable medium of example embodiment 19, wherein generating the system architecture recommendation for the client device based on the dataset and the existing electronic system comprises identifying a constraint associated with the existing electronic system and identifying the at least one integrated circuit device based on the at least one integrated circuit device complying with the constraint.

What is claimed is:

1. A system comprising:
a client device; and
an application programming interface (API) gateway device configured to provide access to integrated circuit device data to the client device using operations comprising:
receiving a request to access a portion of integrated circuit device data from the client device;
determining that the client device has access privileges to the requested portion of integrated circuit device data;
retrieving the requested portion of integrated circuit device data from a plurality of databases; and
providing the client device with access to the requested portion of integrated circuit device data.

2. The system of claim 1, wherein the API gateway device is configured to:
generate a dataset by transforming the requested portion of integrated circuit device data retrieved from the plurality of databases into a common format;
determine that the dataset comprises confidential data; and
remove the confidential data from the dataset before providing the client device with access to the requested portion of integrated circuit device data.

3. The system of claim 1, wherein the integrated circuit device data comprises an availability of an integrated circuit device, a cost of the integrated circuit device, a protocol compatibility of the integrated circuit device, one or more intellectual property (IP) cores associated with the integrated circuit device, a driver compatibility with the integrated circuit device, or any combination thereof.

4. The system of claim 1, wherein the client device comprises a system architecture recommendation system that is configured to generate an integrated circuit device recommendation based on a received target specification.

5. The system of claim 4, wherein the system architecture recommendation system is configured to access a large language model (LLM), the LLM being configured to generate the requested portion of integrated circuit device data based on the received target specification and query the API gateway device for the requested portion of integrated circuit device data.

6. The system of claim 4, wherein the integrated circuit device recommendation comprises a comparison between at least two integrated circuit devices.

7. The system of claim 4, wherein the plurality of databases are associated with multiple integrated circuit device manufacturers, the multiple integrated circuit device manufactures comprising a first party integrated circuit device manufacturer and a third party integrated circuit device manufacturer, wherein the first party integrated circuit device manufacturer hosts the API gateway device.

8. The system of claim 4, wherein the system architecture recommendation system is configured to generate a compatibility metric for an integrated circuit device associated with the integrated circuit device recommendation, the compatibility metric comprising an expected performance of the integrated circuit device in an existing electronic system.

9. The system of claim 1, wherein at least one database of the plurality of databases comprises an intellectual property (IP) catalog comprising IP cores to be implemented in field programmable gate arrays (FPGAs).

10. A method comprising:
receiving one or more target specifications for an integrated circuit device;
accessing integrated circuit device data via an application programming (API) gateway, the API gateway comprising a communicative connection to a plurality of external databases comprising integrated circuit device specifications; and
retrieving a set of data from the integrated circuit device data based on the one or more target specifications.

11. The method of claim 10, comprising:
identifying, via a system architecture recommendation system, a recommendation for an integrated circuit device based on the set of data and the one or more target specifications; and
transmitting the recommendation to a client device.

12. The method of claim 11, wherein the system architecture recommendation system comprises one or more large language models (LLMs) configured to query the API gateway to retrieve the set of data based on the one or more target specifications.

13. The method of claim 11, comprising: identifying an electronic system associated with the client device based on metadata associated with a client device, a cloud data structure comprising data associated with the client device, or any combination thereof, wherein the recommendation is further based on the electronic system.

14. The method of claim 10, wherein the target specifications comprise a protocol compatibility of the integrated circuit device, one or more intellectual property (IP) cores associated with the integrated circuit device, a driver compatibility with the integrated circuit device, or any combination thereof.

15. The method of claim 10, comprising transmitting an indication of an integrated circuit device product release or integrated circuit device product update to a client device based on integrated circuit device data.

16. A non-transitory, computer-readable medium, comprising computer-readable instructions that, when executed by one or more processors of one or more computers, cause the one or more computers to:
receive a plain language request for integrated circuit device data;
query multiple data sources via an application programming interface (API) gateway to retrieve the integrated circuit device data based on the plain language request, the multiple data sources comprising internal integrated circuit device databases and external integrated circuit device data; and
generate a dataset based on a portion of the retrieved integrated circuit device data that is responsive to the plain language request.

17. The non-transitory, computer-readable medium of claim 16, wherein the integrated circuit device data comprises multiple intellectual property (IP) core catalogs associated with multiple integrated circuit device vendors.

18. The non-transitory, computer-readable medium of claim 16, wherein the computer-readable instructions cause the one or more computers to:
parse the multiple data sources to identify a change in the integrated circuit device data indicating a product release or update; and
transmit an indication to a client device based on the change in the integrated circuit device data indicating the product release or update.

19. The non-transitory, computer-readable medium of claim 16, wherein the plain language request for integrated circuit device data is received from a client device, and the computer-readable instructions cause the one or more computers to:
identify an existing electronic system associated with the client device; and
generate a system architecture recommendation for the client device based on the dataset and the existing electronic system, the system architecture recommendation comprising at least one integrated circuit device.

20. The non-transitory, computer-readable medium of claim 19, wherein generating the system architecture recommendation for the client device based on the dataset and the existing electronic system comprises identifying a constraint associated with the existing electronic system and identifying the at least one integrated circuit device based on the at least one integrated circuit device complying with the constraint.
